(19) United States
(12) Patent Application Publication
(10) Pub. No.: US 2014/0218972 A1
(43) Pub. Date: Aug. 7, 2014

(54) LIGHT GUIDING APPARATUS AND LIGHT SOURCE DEVICE INCLUDING THE SAME

(71) Applicants: Ming-Chuan Lin, Taichung City (TW); Kuo-Jui Huang, Taichung City (TW); Chang-Wei Yu, Nantou County (TW); Hsiu-Ping Lee, Taichung City (TW); Ping-Yeng Chen, Taichung City (TW)

(72) Inventors: Ming-Chuan Lin, Taichung City (TW); Kuo-Jui Huang, Taichung City (TW); Chang-Wei Yu, Nantou County (TW); Hsiu-Ping Lee, Taichung City (TW); Ping-Yeng Chen, Taichung City (TW)

(73) Assignee: WINTEK CORPORATION, Taichung City (TW)

(21) Appl. No.: 14/166,791

(22) Filed: Jan. 28, 2014

(30) Foreign Application Priority Data
Feb. 1, 2013 (TW) 102202297

(51) Int. Cl. F21V 8/00

(52) U.S. Cl. CPC G02B 6/0076
USPC 362/616

(57) ABSTRACT

A light guiding apparatus includes a light guiding apparatus and a second light guide. The first light guide includes a first end-surface, a second end-surface and a side-surface, in which the first end-surface includes a first light incident surface thereon, the second end-surface includes a first light emitting surface thereon, and the side-surface is located between the first end-surface and the second end-surface of the first light guide. The second light guide has a second incident surface and a second light emitting surface connecting the second incident surface, in which at least a partial region of the second light emitting surface is a roughened surface, the second incident surface or the first light emitting surface is a roughened surface, and the second incident surface is corresponding to the first light emitting surface.

### CROSS-REFERENCE TO RELATED APPLICATION

This application claims the priority benefit of Taiwan application serial no. 102202297, filed on Feb. 1, 2013. The entirety of the above-mentioned patent application is hereby incorporated by reference herein and made a part of this specification.

### BACKGROUND

1. Field of the Utility Model

The present invention generally relates to a light source device, and particularly, to a light source device having a light guiding apparatus.

2. Description of Related Art

A conventional light source device in a crystal lamp is designed according to the tungsten light source at the center of a lampshade. Tungsten-based light-emitting mechanism, however, is very power-consumed, and it features short life and high power-loss rate.

In recent years, with the good development of the light emitting diode (LED) light source development, another option of the light source device is available, which can achieve power-saving and other characteristics. In the crystal lamp using the conventional light source apparatus having the LED, the LED is disposed at an end of a cylinder light guiding apparatus, where the light is guided by the cylinder light guiding apparatus to the other end to achieve light transmission effect.

It should be noted that, in the prior art, in order to further increase the light emission angle of the light source device, the optical surfaces of the light guiding apparatus are designed to make the light beams reflected to become dispersed. However, merely relying on the design of the optical surfaces of the light guiding apparatus for distributing the light beams has a defect of uneven distribution, which likely causes noticeable bright lines occurred when such a light source device is close to a wall surface, and therefore, it causes a poor visual effect for a user in the habit of the tungsten-based light emitting device for long term already.

Thus, how to make a light guiding apparatus uniformly guide out the LED source and to increase the visual effect has become an issue to be primarily resolved in this field today.

### SUMMARY OF THE DISCLOSURE

Accordingly, the present invention is directed to a light source device, which has good light uniformity and provides a novel light emitting effect.

The invention provides a light source device including a light guiding apparatus and a light emitting element. The light guiding apparatus includes a first light guide and a second light guide. The first light guide includes a first end-surface, a second end-surface and a side-surface, in which the first end-surface includes a first light incident surface thereon, the second end-surface includes a first light emitting surface thereon, and the side-surface is located between the first end-surface and the second end-surface of the first light guide. The second light guide has a second incident surface and a second light emitting surface connecting the second incident surface, in which at least a partial region of the second light emitting surface is a roughened surface, the second incident surface or the first light emitting surface is a roughened surface, the second incident surface is corresponding to the first light emitting surface, and a medium with a refractive index less than the refractive indexes of the first light guide and the second light guide is located between the second incident surface and the first light emitting surface.

In an embodiment of the invention, the side-surface has a first region and a second region, the first region adjoins the first light incident surface, the second region adjoins the first light emitting surface, the normal at an arbitrary point of the second region of the side-surface is set as a first axis direction, the connection line between the arbitrary point and a center of the first light incident surface is set as a second axis direction, then, the sine of an included angle between the first axis direction and the second axis direction is greater than the reciprocal of the refractive index of the first light guide.

In an embodiment of the invention, the area of the second region is at least five times of the area of the first region.

In an embodiment of the invention, the roughness (Ra) of the first light emitting surface and the roughened surface of the at least partial region of the second light emitting surface is at least 0.4 μm.

In an embodiment of the invention, the second incident surface is a roughened surface, and roughness (Ra) of the first light emitting surface, the second incident surface and the roughened surface of the at least partial region of the second light emitting surface is at least 0.4 μm.

In an embodiment of the invention, the side-surface further includes a plurality of optical planes, and an included angle between any two adjacent optical planes is unequal to 180°.

In an embodiment of the invention, the first light guide has a first locking portion, the second light guide has a second locking portion, a part of the first locking portion is the first light emitting surface, and a part of the second locking portion is the second incident surface.

In an embodiment of the invention, the first light emitting surface has a recessed portion, at least a part of the second incident surface forms an embedding portion, and the shapes of the recessed portion and the embedding portion are complementary to each other.

In an embodiment of the invention, the embedding portion is a pyramid or a cone.

In an embodiment of the invention, the embedding portion is adhered with the recessed portion.

In an embodiment of the invention, the first light guide has a first refractive index, the second light guide has a second refractive index, the medium between the second incident surface and the first light emitting surface has a third refractive index, and the difference between the third refractive index and the first refractive index or the second refractive index is at least 0.5. For example, the medium can be air or adhesive.

In an embodiment of the invention, the side-surface is a smooth surface.

In an embodiment of the invention, the light emitting element is disposed adjacently to the first light incident surface.

In an embodiment of the invention, the light emitting element includes a light emitting diode (LED).

In an embodiment of the invention, the light source device further includes a lampshade to cover the light guiding apparatus.

Based on the description above, the invention can effectively reduce the problem of uneven light scattering faced by the prior art through the design of the first light guide and the second light guide of the light guiding apparatus, and thereby the light source device of the invention has good light uniformity.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is an exploded diagram of a light source device according to an embodiment of the invention.

FIG. 2 is a cross-sectional diagram of FIG. 1 along I-I′.

FIGS. 3A to 3C are three-dimensional diagrams of a second light guide according to multiple embodiments of the invention.

FIG. 4 is an illumination chart of a light source device according to an embodiment of the invention.

FIG. 5 is a light distribution curve chart of a light source device according to an embodiment of the invention.

### DESCRIPTION OF THE EMBODIMENTS

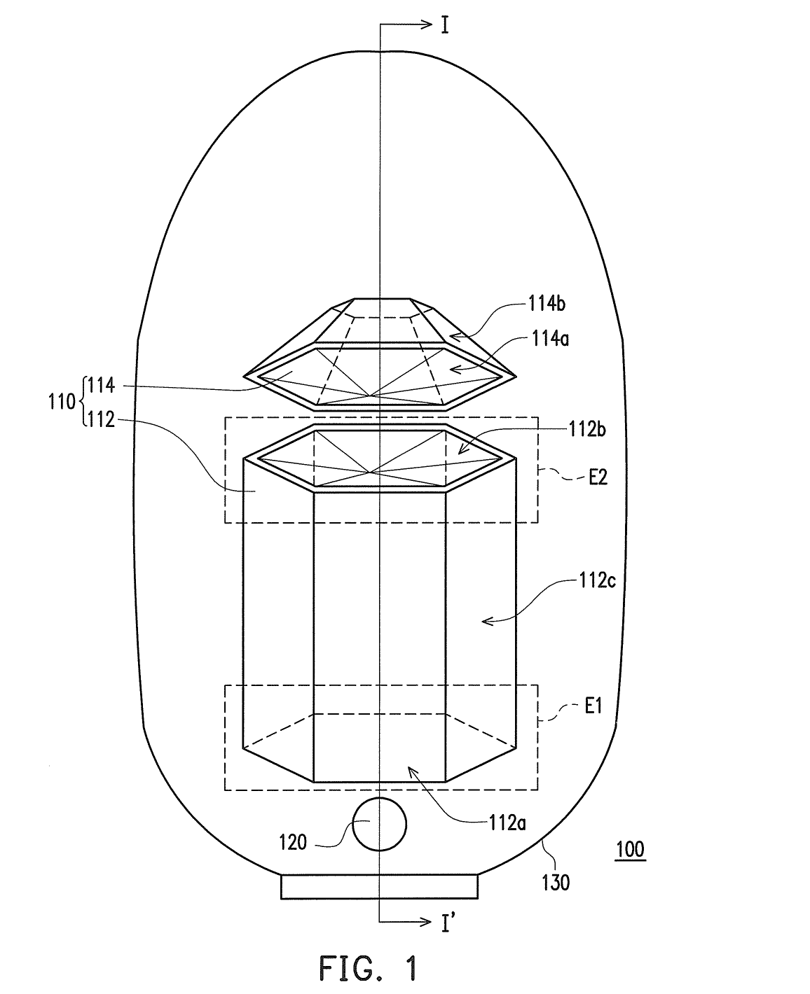

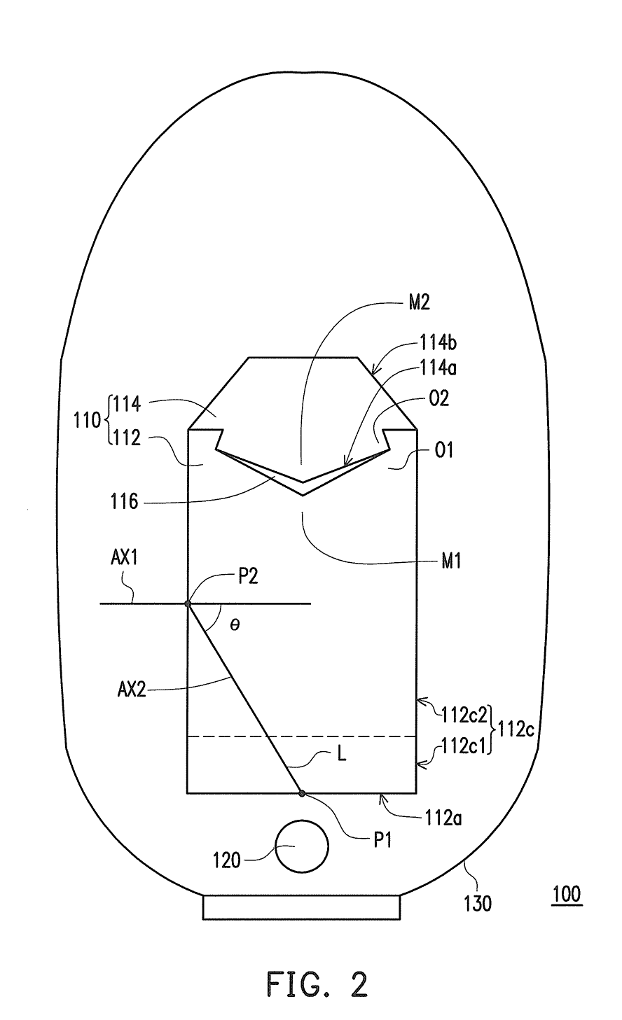

FIG. 1 is an exploded diagram of a light source device according to an embodiment of the invention and FIG. 2 is a cross-sectional diagram of FIG. 1 along I-I′. Referring to FIGS. 1 and 2, in the embodiment, a light source device 100 includes a light guiding apparatus 110, a light emitting element 120 and a lampshade 130. The light guiding apparatus 110 includes a first light guide 112 and a second light guide 114. The first light guide 112 includes a first end-surface E1, a second end-surface E2 and a side-surface 112c. The first end-surface E1 includes a first incident surface 112a thereon, the second end-surface E2 includes a first light emitting surface 112b thereon, and the side-surface 112c is located between the first end-surface E1 and the second end-surface E2 of the first light guide 112. The second light guide 114 has a second incident surface 114a and a second light emitting surface 114b connecting the second incident surface 114a, in which at least a partial region of the second light emitting surface 114b is a roughened surface, and the second incident surface 114a or the first light emitting surface 112b is a roughened surface. The second incident surface 114a is disposed correspondingly to the first light emitting surface 112b so that the first light emitting surface 112b and the second incident surface 114a can be optical coupled. For example, the second incident surface 114a is disposed to face the first light emitting surface 112b. There is a medium 116 between the second incident surface 114a and the first light emitting surface 112b, in which the refractive index of the medium 116 is less than the refractive indexes of the first light guide 112 and the second light guide 114. In addition, the lampshade 130 is used to cover the light guiding apparatus 110, and the light source device 100 can be applied in various illumination systems such as crystal lamp, showcase light, votive lamp, standing lamp or situation showing light.

In the embodiment, the first light guide 112 and the second light guide 114 in the light guiding apparatus 110 can be fabricated by injection molding and can have the same materials, for example, polymethylmethacrylate (PMMA) or other light-guidable transparent materials.

In the embodiment, the light emitting element 120 is disposed adjacently to the first incident surface 112a, and the light emitting element 120 can include LEDs or a linear light source of other types, which the invention is not limited to.

In the embodiment, the light emitting element 120 provides a light beam L to be transmitted in the first light guide 112. First, the light beam L passing through the first incident surface 112a enters the first light guide 112 and is totally reflected many times by the side-surface to be transmitted to the first light emitting surface 112b. Next, the light beam L is via the first light emitting surface 112b and the medium 116, then, the light beam L enters the second light guide 114 via the second light incident surface 114a thereafter departs from the second light guide 114 via the second light emitting surface 114b. Wherein, the light beam L is diffused at least twice, once by the roughened surface of the first light emitting surface 112b or the second light emitting surface 114b, and another once by the roughened surface of the second light emitting surface 114b.

In the embodiment, the refractive index of the first light guide 112 of the light guiding apparatus 110 is n1 (first refractive index), the refractive index of the second light guide 114 is n2 (second refractive index) and the refractive index of the medium 116 is n3 (third refractive index). The refractive index nₐᵢᵣ of air is 1.00, in which the difference between the refractive index n3 of the medium 116 and the refractive index n1 of the first light guide 112 or the refractive index n2 of the second light guide 114 can be over 0.5. As a result, after the light beam L via the roughened surface of the first light emitting surface 112b can be effectively diffused so as to advance the light uniformity of the light source device 100.

Referring to FIG. 1, in the embodiment, the side-surface 112c of the first light guide 112 includes a plurality of optical planes, and the included angles between the optical planes are unequal to 180°. Thereby, the user can observe the images from the side-surface 112c and the superposition of light and shadow so as to provide special visual effects. For example, the side-surface 112c can include six optical planes, which the invention is not limited to.

Referring to FIG. 2, the side-surface 112c of the first light guide 112 can have a first region 112c1 and a second region 112c2. The first region 112c1 adjoins the first incident surface 112a, the second region 112c2 adjoins the first light emitting surface 112b, and the area of the second region 112c2 can be at least five times of the area of the first region 112c1.

Assuming the second region 112c2 located at the side-surface 112c has a point P2 and the point P2 can be located at an arbitrary position of the second region 112c2. The normal at the point P2 is a first axis direction AX1, the connection line between the point P2 and the center P1 of the first incident surface 112a is a second axis direction AX2, and the included angle between the first axis direction AX1 and the second axis direction AX2 is θ.

In the embodiment, when the light beam L come from the center P1 of the first incident surface 112a arrives at the point P2, the incident angle of the light beam L at the time when the light beam L enters the air via the side-surface 112c is equal to the included angle θ. It can be seen in FIG. 2 that a refraction angle θ_{light} of the light beam L is between 0° and 90°. According to Snell's law (Eq. 1), it can be derived that when the sine of the included angle θ is greater than the reciprocal of the refractive index n1 of the first light guide 112, the light beam L can be transmitted in the first light guide 112 by total reflection via the side-surface 112c, which can reduce the intensity decay of the light beam L during transmitting.

nₐᵢᵣ×sinθ_{light}=n1×sinθ (Eq. 1)

In addition, the first incident surface 112a and the side-surface 112c can be smooth surfaces so as to prevent the light beam L from being diffused at the first incident surface 112a and the side-surface 112c and from loss during the transmitting thereof to the first light emitting surface 112b.

In the embodiment, the second light guide 114 has the second incident surface 114a and the second light emitting surface 114b connecting the second incident surface 114a, in which at least a partial region of the second light emitting surface 114b is a roughened surface so as to improve the effect of light emitting of the second light emitting surface 114b to advance the light uniformity.

In addition, in the embodiment, when the first light emitting surface 112b and the at least partial region of the second light emitting surface 114b are roughened surface, the roughness of the roughened surface is at least 0.4 m so as to improve the effect of light emitting and advance the light uniformity.

In the embodiment, the second incident surface 114a can be roughened surface, and the roughness (Ra) of the first light emitting surface 112b, the second incident surface 114a and the roughened surface of the at least partial region of the second light emitting surface 114b is at least 0.4 μm so as to further improve the effect of light emitting and advance the light uniformity.

In the embodiment, the roughened surface is able to make the light beam diffused and the roughened surface can be formed by performing etching process, sand-blasting treatment or texturing treatment.

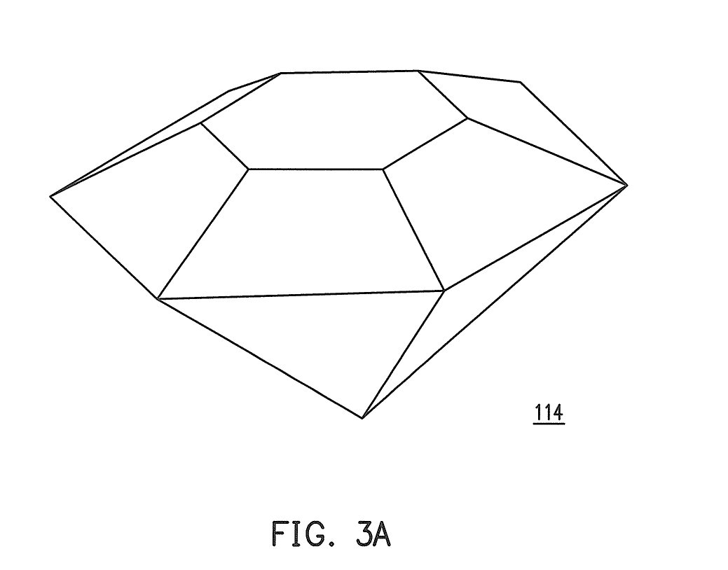

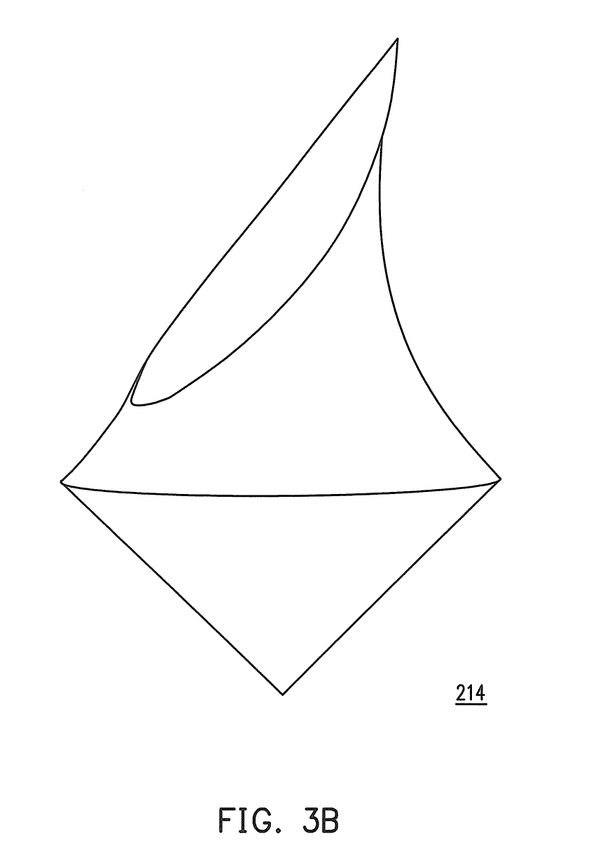

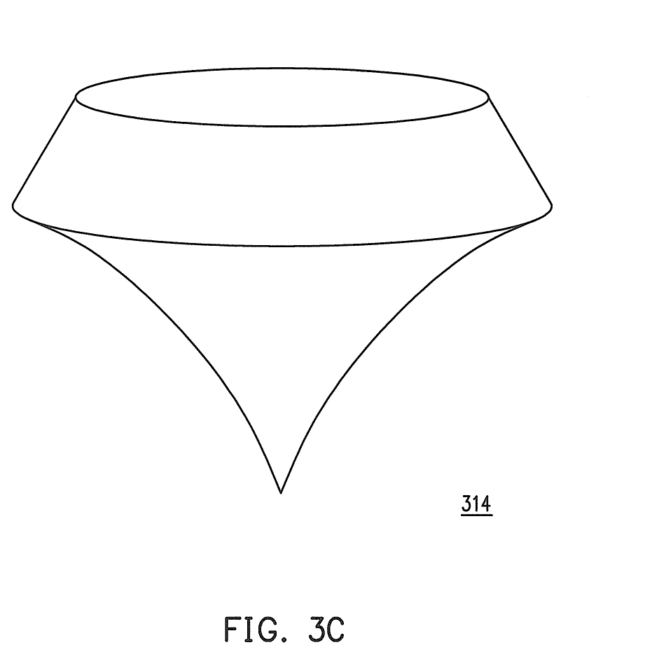

It should be noted that in the embodiment, the first light emitting surface 112b has a recessed portion M1 and at least a part of the second incident surface 114a forms an embedding portion M2. The cross-sectional surface of the recessed portion M1 in the embodiment includes an inclined surface. In order to effectively avoid undue aggregation of the light beam which is passing through the optical surface of the recessed portion M1, the optical surface of the recessed portion M1 can be the above-mentioned roughened surface so as to advance the uniformity of light distribution. FIGS. 3A-3C are three-dimensional diagrams of a second light guide according to multiple embodiments of the invention. Referring to FIGS. 3A-3C, the second light emitting surface 114b of the second light guide 114 can have any shape, the embedding portion M2 of the second light guide 114 can be a pyramid or a cone, and the shape of the recessed portion M1 is corresponding to the shape of the embedding portion M2, i.e., the shapes of the recessed portion M1 and the embedding portion M2 are complementary to each other. Specifically, the space of the recessed portion M1 of the first light guide 112 is big enough to accommodate the embedding portion M2 of the second light guide 114; the shapes of the recessed portion M1 and the embedding portion M2 are corresponding to each other so that the embedding portion M2 can be smoothly embedded into the recessed portion M1; the embedding portion M2 and the recessed portion M1 can be connected to each other by locking or adhering one another, which the invention is not limited to.

In the embodiment, the first light guide 112 has a first locking portion O1, the second light guide 114 has a second locking portion O2, a part of the first locking portion O1 is the first light emitting surface 112b, a part of the second locking portion O2 is the second incident surface 114a, and in this way, the first locking portion O1 and the second locking portion O2 can lock one another. When the light guiding apparatus 110 is applied in the light source device 100, the above-mentioned design enables the second light guide 114 and the first light guide 112 to be tightly connected to each other without easily being separated from each other.

It should be noted that, in the embodiment, at least a part of the light beam come from the light emitting device gets total reflection at the side-surface.

In more details, by using the side-surface 112c to make the light beam L get total reflection and by the design that the first light emitting surface 112b has the recessed portion M1, the first light emitting surface 112b or the second incident surface 114a is the roughened surface and the second light emitting surface 114b is the roughened surface, the invention helps to make the light beam scattered towards the surrounding direction away from a central axis of the light emitting element 120, and the direction toward where the light emitting device 120 is disposed so that the user can observe the scattering light at the second light guide 114 and the recessed portion M1 which is like that the second light guide 114 is floated in air and a specific visual effect can be obtained.

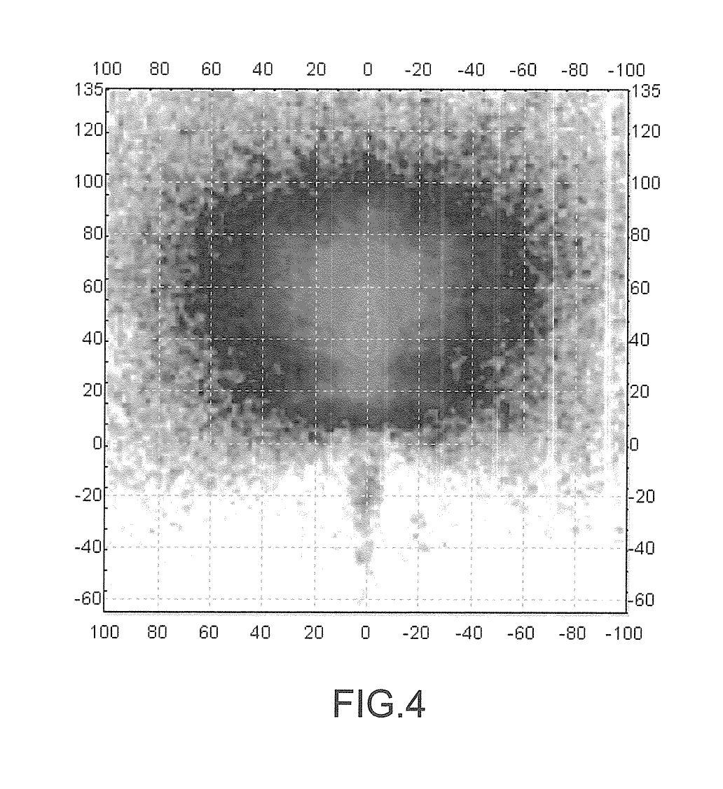

FIG. 4 is an illumination chart of a light source device according to an embodiment of the invention. Referring to FIG. 4, it can be seen that the light source device of the invention can provide uniform and symmetrical light distribution, and the displaying light beam has good uniformity after scattering many times.

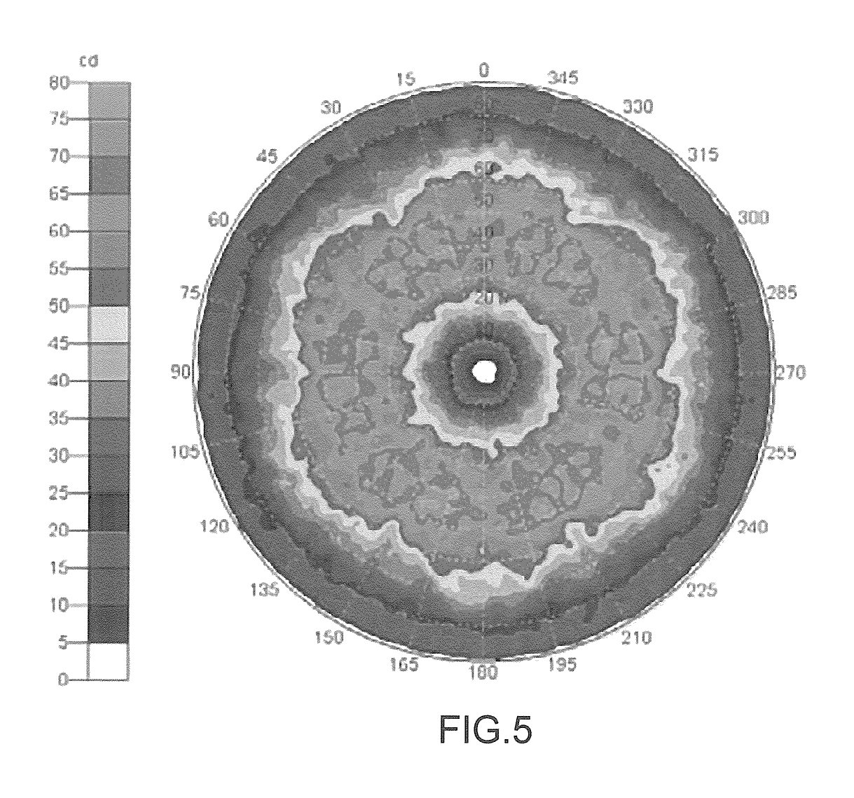

FIG. 5 is a light distribution curve chart of a light source device according to an embodiment of the invention. As shown by FIG. 5, the light source device of the invention can provide uniform and symmetrical light distribution, and the displaying light beam has good uniformity after scattering many times.

In summary, the light source device of the invention can effectively reduce the uniform beam problem in the prior art and has good performance on the visual effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light guiding apparatus, comprising:
a first light guide comprising a first end-surface, a second end-surface and a side-surface, wherein the first end-surface comprises a first light incident surface thereon, the second end-surface comprises a first light emitting surface thereon, and the side-surface is located between the first end-surface and the second end-surface of the first light guide; and
a second light guide having a second incident surface and a second light emitting surface connecting the second incident surface, wherein at least a partial region of the second light emitting surface is a roughened surface, the second incident surface or the first light emitting surface is a roughened surface, the second incident surface is corresponding to the first light emitting surface, and a medium with a refractive index less than the refractive indexes of the first light guide and the second light guide is located between the second incident surface and the first light emitting surface.

2. The light guiding apparatus as claimed in claim 1, wherein the side-surface has a first region and a second region, the first region adjoins the first light incident surface, the second region adjoins the first light emitting surface, a normal at an arbitrary point of the second region of the side-surface is set as a first axis direction, a connection line between the an arbitrary point and a center of the first light incident surface is set as a second axis direction, then, sine of an included angle between the first axis direction and the second axis direction is greater than a reciprocal of the refractive index of the first light guide.

3. The light guiding apparatus as claimed in claim 2, wherein area of the second region is at least five times of area of the first region.

4. The light guiding apparatus as claimed in claim 1, wherein a roughness (Ra) of the first light emitting surface and the roughened surface of the at least partial region of the second light emitting surface is at least 0.4 μm.

5. The light guiding apparatus as claimed in claim 1, wherein the second incident surface is a roughened surface, and a roughness (Ra) of the first light emitting surface, the second incident surface and the roughened surface of the at least partial region of the second light emitting surface is at least 0.4 μm.

6. The light guiding apparatus as claimed in claim 1, wherein the side-surface further comprises a plurality of optical planes, and an included angle between any two adjacent optical planes is unequal to 180°.

7. The light guiding apparatus as claimed in claim 1, wherein the first light guide has a first locking portion, the second light guide has a second locking portion, a part of the first locking portion is the first light emitting surface, and a part of the second locking portion is the second incident surface.

8. The light guiding apparatus as claimed in claim 1, wherein the first light emitting surface has a recessed portion, at least a part of the second incident surface forms an embedding portion, and shapes of the recessed portion and the embedding portion are complementary to each other.

9. The light guiding apparatus as claimed in claim 8, wherein the embedding portion is a pyramid or a cone.

10. The light guiding apparatus as claimed in claim 8, wherein the embedding portion is adhered with the recessed portion.

11. The light guiding apparatus as claimed in claim 1, wherein the first light guide has a first refractive index, the second light guide has a second refractive index, the medium between the second incident surface and the first light emitting surface has a third refractive index, and difference between the third refractive index and the first refractive index or the second refractive index is at least 0.5.

12. The light guiding apparatus as claimed in claim 1, wherein the side-surface is a smooth surface.

13. A light source device, comprising:
a light guiding apparatus, including:
a first light guide comprising a first end-surface, a second end-surface and a side-surface, wherein the first end-surface comprises a first light incident surface thereon, the second end-surface comprises a first light emitting surface thereon, and the side-surface is located between the first end-surface and the second end-surface of the first light guide; and
a second light guide having a second incident surface and a second light emitting surface connecting the second incident surface, wherein at least a partial region of the second light emitting surface is a roughened surface, the second incident surface or the first light emitting surface is a roughened surface, the second incident surface is corresponding to the first light emitting surface, and a medium with a refractive index less than the refractive indexes of the first light guide and the second light guide is located between the second incident surface and the first light emitting surface; and
a light emitting element, wherein the light emitting device is disposed adjacently to the first light incident surface.

14. The light source device as claimed in claim 13, wherein the light emitting device comprises a light emitting diode.

15. The light source device as claimed in claim 13, further comprising a lampshade to cover the light guiding apparatus.

16. The light source device as claimed in claim 13, wherein the side-surface of the light guiding apparatus has a first region and a second region, the first region adjoins the first light incident surface, the second region adjoins the first light emitting surface, a normal at an arbitrary point of the second region of the side-surface is set as a first axis direction, a connection line between the an arbitrary point and a center of the first light incident surface is set as a second axis direction, then, sine of an included angle between the first axis direction and the second axis direction is greater than a reciprocal of the refractive index of the first light guide.

17. The light source device as claimed in claim 16, wherein area of the second region is at least five times of area of the first region.

18. The light source device as claimed in claim 13, wherein a roughness (Ra) of the first light emitting surface and the roughened surface of the at least partial region of the second light emitting surface is at least 0.4 μm.

19. The light source device as claimed in claim 13, wherein the first light guide has a first locking portion, the second light guide has a second locking portion, a part of the first locking portion is the first light emitting surface, and a part of the second locking portion is the second incident surface.

20. The light source device as claimed in claim 13, wherein the first light guide has a first refractive index, the second light guide has a second refractive index, the medium between the second incident surface and the first light emitting surface has a third refractive index, and difference between the third refractive index and the first refractive index or the second refractive index is at least 0.5.

21. The light source device as claimed in claim 13, wherein the medium is air or adhesive.
